(19) United States
(12) Patent Application Publication
(10) Pub. No.: US 2026/0175753 A1
(43) Pub. Date: Jun. 25, 2026

(54) VEHICLE SEAT

(71) Applicant: TOYOTA JIDOSHA KABUSHIKI KAISHA, Toyota-shi (JP)

(72) Inventors: Kohshi KATOH, Hadano-shi (JP); Koki KUNUGI, Fuji-shi (JP); Ryosuke TANAHASHI, Mishima-shi (JP); Masatoshi HADA, Nisshin-shi (JP)

(73) Assignee: TOYOTA JIDOSHA KABUSHIKI KAISHA, Toyota-shi (JP)

(21) Appl. No.: 19/285,454

(22) Filed: Jul. 30, 2025

(30) Foreign Application Priority Data
Dec. 25, 2024 (JP) 2024-229290

(51) Int. Cl. B60N 2/50; B60N 2/54; B60N 2/66

(52) U.S. Cl. CPC B60N 2/503; B60N 2/542; B60N 2/6671

(57) ABSTRACT

A vehicle seat includes a seatback frame erected from a rear end portion of a seat cushion, a seatback pad disposed on a seat front surface side of the seatback frame and supporting a back of an occupant, a first support member having an elongated shape and disposed between the seatback frame and the seatback pad, the first support member being configured to extend in a direction inclined relative to a seat width direction and to transmit a reaction force to the back of the occupant through tension, and a second support member having an elongated shape and disposed between the seatback frame and the seatback pad, the second support member being configured to extend in a direction inclined with respect to the seat width direction to intersect the first support member at a lumbar region, and to transmit a reaction force to the back of the occupant through tension.

### CROSS-REFERENCE TO RELATED APPLICATION

This application claims priority to Japanese Patent Application No. 2024-229290 filed on Dec. 25, 2024. The disclosure of the above-identified application, including the specification, drawings, and claims, is incorporated by reference herein in its entirety.

### BACKGROUND

### 1. Technical Field

The present disclosure relates to a vehicle seat.

### 2. Description of Related Art

In the related art, a vehicle seat has been proposed in order to suppress a sense of fatigue of an occupant caused by vehicle sway occurring during traveling of a vehicle or an external force generated during cornering, the vehicle seat being capable of appropriately adjusting a posture of the occupant.

As an example, in the technique described in Japanese Unexamined Patent Application Publication No. 2020-059492 (JP 2020-059492 A), when a seated posture of the occupant is changed due to vehicle sway or the like of the vehicle, the posture of the occupant is stabilized by a wire stretched parallel to a width direction of a seatback from a frame of a sub-frame.

### SUMMARY

However, in the related art described above, a posture stabilization method for the occupant is solely an elastic force adjustor using the wire stretched in parallel, and there is room for improvement from the viewpoint of improving vertical stability of the vehicle in a roll direction.

An object of the present disclosure is to obtain a vehicle seat that can improve a holding performance for the upper torso and stability of the head of the occupant, during the traveling of the vehicle, particularly during the cornering, in consideration of the facts.

A vehicle seat according to the present disclosure of a first aspect includes
a seatback frame erected from a rear end portion of a seat cushion,
a seatback pad disposed on a seat front surface side of the seatback frame and supporting a back of an occupant,
a first support member having an elongated shape and disposed between the seatback frame and the seatback pad, the first support member being configured to extend in a direction inclined with respect to a seat width direction and to transmit a reaction force to the back of the occupant through tension, and
a second support member having an elongated shape and disposed between the seatback frame and the seatback pad, the second support member being configured to extend in a direction inclined with respect to the seat width direction to intersect the first support member at a lumbar region, and to transmit a reaction force to the back of the occupant through tension.

According to the present disclosure of the first aspect, in general, when a steering operation for cornering is performed by the occupant, the shoulder region on an outer side of the upper torso of the occupant in a cornering direction is displaced toward the front side of the vehicle in plan view, and the lumbar region is displaced toward the rear side of the vehicle. As a result, a driving operation becomes easy for the occupant to perform. However, on the other hand, a seat reaction force near the lumbar region of the occupant on an inner side of the cornering direction is reduced, and a pressure distribution of a backrest tends to be biased toward an outer side of the cornering direction.

Here, in the present disclosure, the first support member having an elongated shape is disposed between the seatback frame and the seatback pad, the first support member being configured to extend in a direction inclined with respect to the seat width direction. Therefore, in a case where the lumbar region on the outer side of the cornering direction is displaced toward the rear side of the vehicle, tension is generated in the first support member, and the tension can be transmitted, via the first support member, to the shoulder region on the inner side of the cornering direction as a reaction force. That is, the reaction force toward the vicinity of the shoulder region on the inner side of the cornering direction can be ensured. As a result, the fit between the seatback and the entirety of the upper torso of the occupant is improved.

In addition, the first support member and the second support member are disposed to be inclined with respect to the seat width direction to intersect at the lumbar region of the occupant. Therefore, a center point of the pressure of the seatback received by the back of the occupant shifts toward an upper side of the seat, and a shear moment resisting a cornering G is easily obtained, as compared with a case where the support member is extended horizontally in the seat width direction.

As a result, according to the present disclosure, the holding performance for the upper torso and the stability of the head of the occupant are improved during the traveling of the vehicle, particularly during the cornering.

The vehicle seat according to the present disclosure of a second aspect further includes, in the disclosure of the first aspect,
a third support member having an elongated shape, the third support member being configured to extend in the seat width direction through a sacral region of the occupant and to support the sacral region of the occupant.

According to the present disclosure of the second aspect, since the third support member is configured to extend in the seat width direction through the sacral region of the occupant and to support the sacral region of the occupant, the third support member follows the lumbar region of the occupant that is displaced during the cornering to support the lumbar region, and maintains an upright pelvis posture.

The vehicle seat according to the present disclosure of a third aspect, in the present disclosure of the first aspect, an intersecting portion at which the first support member and the second support member intersect each other is disposed at a position corresponding to a fourth lumbar vertebra of the occupant.

According to the disclosure of the third aspect, since the intersecting portion at which the first support member and the second support member intersect each other is disposed at the position corresponding to the fourth lumbar vertebra of the occupant, the intersecting portion can support the fourth lumbar vertebra that is a lumbar rotation axis of the occupant during the cornering.

In the vehicle seat according to the present disclosure of a fourth aspect, the first support member and the second support member in the disclosure of the first aspect are configured with a wire.

According to the present disclosure of the fourth aspect, the first support member and the second support member are configured with the wire. Therefore, the strength and durability of the member increase, and the structure that generates the reaction force can be maintained, and the maintainability such as re-tensioning of the member is improved.

As described above, the vehicle seat according to the present disclosure of the first aspect has an excellent effect that the holding performance for the upper torso and the stability of the head of the occupant can be improved during the traveling of the vehicle, particularly during the cornering.

The vehicle seat according to the present disclosure of the second aspect has an excellent effect that the stability of the physical balance of the occupant can be improved by maintaining the upright pelvis posture of the occupant.

The vehicle seat according to the present disclosure of the third aspect has an excellent effect that a rotation of the occupant in a yaw direction during the cornering can be suppressed.

The vehicle seat according to the present disclosure of the fourth aspect has an excellent effect that the decrease in the performance of supporting the back of the occupant with respect to the load repeatedly applied from the occupant during the cornering can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a rear perspective view of a vehicle seat according to the present embodiment;

FIG. 1B is a rear view of the vehicle seat of FIG. 1A;

FIG. 2 is a plan view of an occupant during left cornering in a part (A), and a rear view of the occupant during the left cornering in a part (B);

FIG. 3A is a rear view showing a positional relationship between a wire arrangement and a body of the occupant in the vehicle seat according to the present embodiment;

FIG. 3B is a schematic transverse cross-sectional view schematically showing a positional relationship between a body part of the occupant and the wire in FIG. 3A;

FIG. 3C is a rear view showing a positional relationship between the wire arrangement and the body of the occupant in a vehicle seat according to a comparative example;

FIG. 3D is a schematic transverse cross-sectional view schematically showing a positional relationship between the body part of the occupant and the wire in FIG. 3C;

FIG. 4A is a rear view showing a positional relationship between the wire arrangement and the occupant when the vehicle seat is configured to be the smallest;

FIG. 4B is a rear view showing a positional relationship between the wire arrangement and the occupant when the number of wires in the vehicle seat is increased;

FIG. 5 is a schematic diagram in which a part (A) shows a situation in which an external force is applied to an occupant seated in the vehicle seat during a right-cornering, and a part (B) shows a situation in which an external force is applied to the occupant seated in the vehicle seat according to the comparative example during a right-cornering;

FIG. 6A is a front view of the vehicle seat according to the present embodiment; and

FIG. 6B is a front view of the occupant during the right-cornering.

### DETAILED DESCRIPTION OF EMBODIMENTS

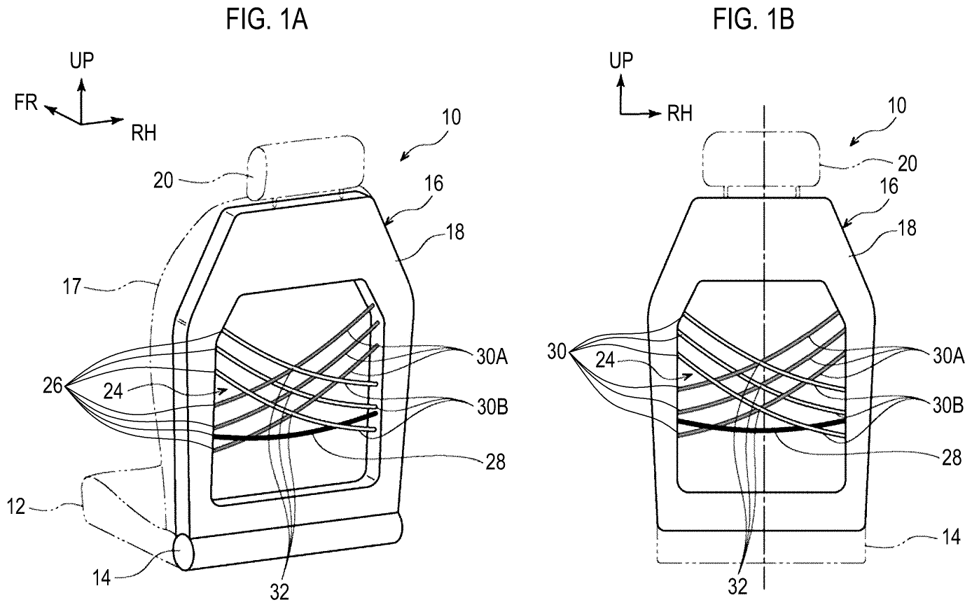

Hereinafter, a vehicle seat 10 according to the present embodiment will be described with reference to FIGS. 1A to 6B. In each drawing, as appropriate, an arrow UP indicates an upward direction of the vehicle, an arrow FR indicates a front side in a vehicle front-rear direction, and an arrow RH indicates a right side in a vehicle width direction.

### Overall Structure of Vehicle Seat 10

FIG. 1A is a perspective view showing the entirety of the vehicle seat 10 according to the present embodiment. In addition, FIG. 1B is a rear view of the vehicle seat 10 according to the present embodiment. As shown in the drawings, the vehicle seat 10 according to the present embodiment includes a seat cushion 12 on which an occupant sits, a seatback 16, and a headrest 20 supported to be movable up and down on an upper end portion of the seatback 16. Here, the seatback 16 is rotatably supported around a support shaft 14 at the rear end portion of the seat cushion 12 to be a backrest. The support shaft 14 shown in FIG. 1A is a schematic view of a connecting rod (not shown) disposed at a rear end portion of a seat cushion frame that is a skeletal member of the seat cushion 12 in the seat width direction as an axial direction.

The seat cushion 12 extends in a seat front-rear direction and the seat width direction, and is configured to support a buttocks and the thighs of the occupant from a lower side of the seat. In addition, the seat cushion 12 is movably supported by a pair of right and left seat slide rails (not shown) arranged on a vehicle body floor.

The seatback 16 includes a seatback pad 17 for supporting the back of the

occupant and a metal seatback frame 18 as a skeletal member. The headrest 20 for supporting a head H of an occupant is supported on an upper end portion of the seatback frame 18.

### Main Part Structure of Vehicle Seat 10

A plurality of wires 26 are stretched between the seatback frame 18 and the seatback pad 17 disposed on the front side of the seat. More specifically, the wires 26 are strung between a pair of right and left side wall portions that faces each other in the seat width direction at an opening portion of the seatback frame 18 provided in a substantially rectangular frame shape when viewed from the rear side. With the provision of the wires 26, when the posture of the upper torso of the occupant is changed, the seatback pad 17 is deformed and is supported by the wires 26 such that a load is applied to the wires 26. Hereinafter, the above description will be described in detail.

FIG. 3A is a rear view schematically showing a state in which the wires 26 shown in FIGS. 1A and 1B described above are extracted and attached to a human body. As shown in the drawing, the wires 26 are configured with one horizontal wire 28 stretched substantially parallel to the seat width direction and a total of six inclined wires 30 stretched obliquely to a seat vertical direction with respect to the seat width direction. Each of the wires 26 is made of a material having low bending rigidity and high elasticity.

Among these, the horizontal wire 28 is stretched, when viewed from the rear side, in the seat width direction to support a part corresponding to a sacrum (sacral vertebrae) LA in the lumbar region L of the occupant from the rear side of the seat. In other words, the horizontal wire 28 is stretched to generate tension while following the displacement of the occupant in a yaw direction during the cornering.

On the other hand, the inclined wires 30 are stretched to support the lumbar region L from the shoulder region S of the occupant on a diagonal line. Specifically, the inclined wires 30 are configured with three inclined wires 30A as the first support members and three inclined wires 30B as the second support members. The inclined wires 30A, 30B are arranged in a line symmetry in a case of a disposition state. That is, the inclined wires 30A are stretched from an upper side of a right side portion of the seat to a lower side of a left side portion of the seat, and are strung to pass through a right side of the shoulder region S and a left side of the lumbar region L of the occupant. On the other hand, the inclined wires 30B are stretched from an upper side of the left side portion of the seat to a lower side of the right portion of the seat, and are strung to pass through the left shoulder region S and the right side of the lumbar region L of the occupant.

Each of the inclined wires 30A described above has the same inclination angle with respect to the seat width direction, and is disposed at equal intervals in the seat vertical direction. The inclined wires 30B have the same configuration as the above description.

As an example, the angle of the inclined wires 30 in the present embodiment is determined from the diagonal angle from the edge of the pelvis of the occupant to the under-arm region. More specifically, the inclination angle is an angle of inclination with respect to a horizontal plane orthogonal to the seat vertical direction on the back surface of the seatback frame 18, and is set to an angle not exceeding 55 degrees.

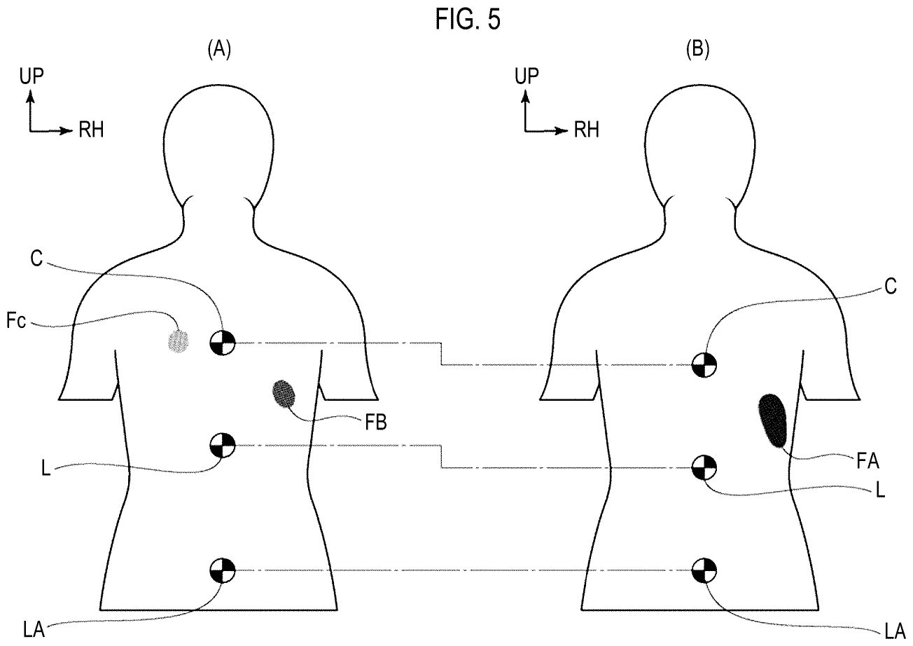

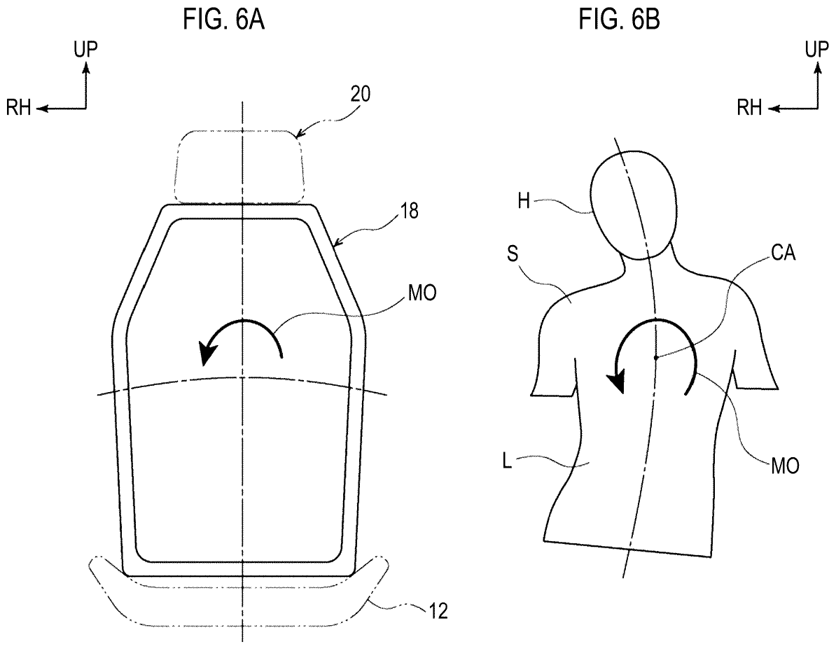

The description of the seated occupant will be supplemented. In the present embodiment, as shown in the part (A) of FIG. 5, the part (B) of FIG. 5, and FIG. 6B, an AM 50 is seated on the vehicle seat 10 in the standard posture as a dummy doll, and a cornering center CA during the cornering is set with the position of a thoracic vertebra C of the AM 50 as a reference. In addition, a position of the lumbar region (lumbar vertebrae) L of the occupant and a position of the sacrum (sacral vertebrae) LA are set as measurement points.

Further, since the inclined wires 30A, 30B are inclined and strung to be a line symmetry when viewed from the rear side, a plurality of intersecting portions 32 are provided as support points supporting the back of the occupant together with the horizontal wire 28.

The intersecting portions 32 are configured with intersecting portions 32A provided by the inclined wires 30A, 30B intersecting each other, the inclined wire 30A positioned at the lowest position, and intersecting portions 32B. The intersecting portion 32B is an intersecting portion in which the inclined wire 30B and the horizontal wire 28 intersect each other.

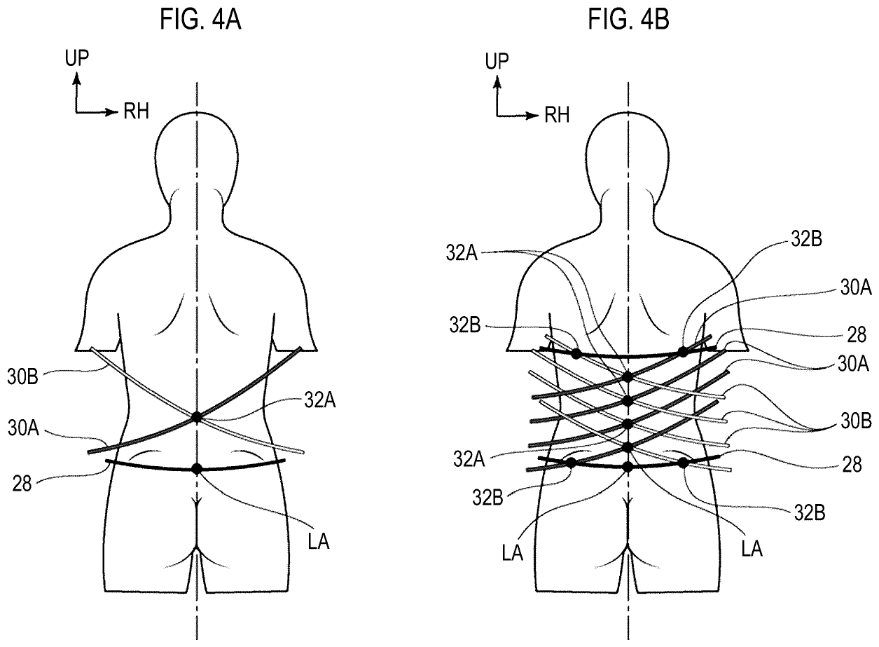

The intersecting portion 32A is disposed at a position where a part corresponding to the spine of the occupant comes into contact. The intersecting portion 32A is provided by disposing the inclined wire 30A on the front side in the seat front-rear direction and by disposing the inclined wire 30B on the rear side in the seat front-rear direction. On an extension line of the intersecting portion 32A, measurement points of the sacral region LA (see FIGS. 3A, 4A, and the part (A) of FIG. 5) and the thoracic vertebra C (see the part (A) of FIG. 5 and the part (B) of FIG. 5) are present.

The intersecting portion 32B is disposed on both right and left sides of the fourth lumbar vertebra L4 in the lumbar region L of the occupant.

FIG. 3B is a schematic view of the occupant in plan view. As shown in the drawing, in the vicinity of the shoulder region, the right side of the shoulder region S is supported by the inclined wire 30A and the left side of the shoulder region S is supported by the inclined wire 30B with the intersecting portion 32 as a boundary. Further, the vicinity of the lumbar region is supported by the inclined wire 30B on the right side and is supported by the inclined wire 30A on the left side with the intersecting portion 32 as a boundary. An arrow P indicates a load applied to the inclined wires 30A, 30B from the occupant, and an arrow F indicates a reaction force received by the occupant from the inclined wires 30A, 30B.

### Action and Effect

Next, the action and effect of the vehicle seat 10 according to the present embodiment will be described.

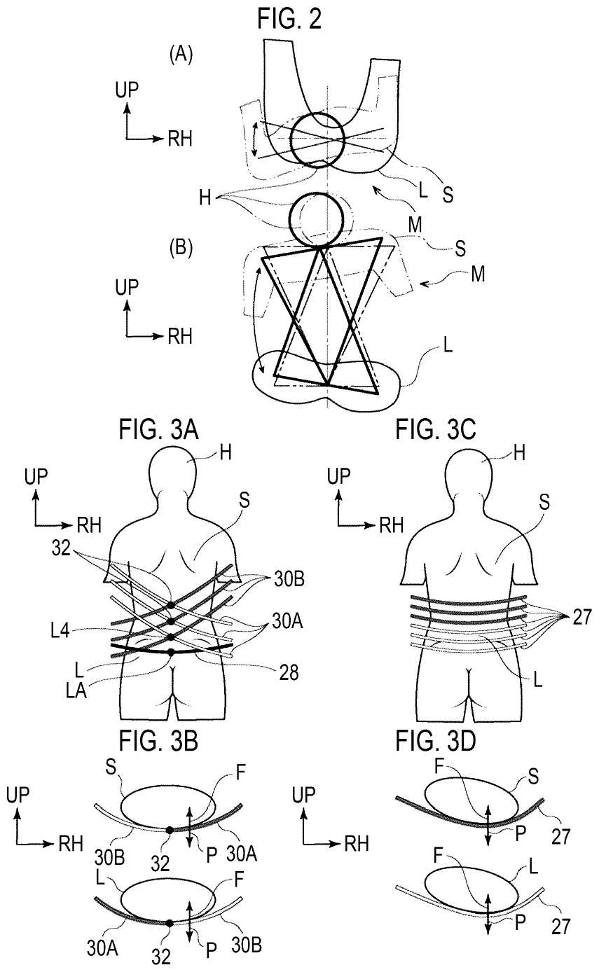

In general, when the steering operation for cornering is performed by the occupant M, as shown in the part (A) of FIG. 2 and the part (B) of FIG. 2, the shoulder region S on the outer side of the upper torso of the occupant M in the cornering direction is displaced toward the front side of the vehicle, and the lumbar region L is displaced toward the rear side of the vehicle. As a result, the occupant M can easily perform the driving operation. Further, a centrifugal force acts on the outer side of the cornering direction of the body by cornering of the vehicle. In this case, as shown in FIG. 3C, in a case of the comparative example in which wires 27 are stretched substantially horizontally, as shown in FIG. 3D, the seat reaction force F near the lumbar region L on the inner side of the cornering direction is reduced, and the pressure distribution of the backrest tends to be biased to the outer side of the cornering direction.

More specifically, in the analyzed result, as shown in the part (B) of FIG. 5, in the case of the comparative example, the distribution of the reaction force received from the seatback 16 appears on the armpit region of the occupant M on the outer side of the cornering direction as a reaction force portion FA. That is, since the upper torso of the occupant M is inclined with the reaction force portion FA as a fulcrum, the part corresponding to the inner side of the cornering direction is not in contact with the seatback 16. Accordingly, as shown in FIG. 3D, the reaction force F from the wire 27 with respect to a resultant force P of the force due to the change in the posture of the occupant M during the cornering and the centrifugal force acting on the occupant due to the cornering of the vehicle is reduced. As a result, the shoulder region S and the lumbar region L of the occupant are inclined to the outer side of the cornering direction.

Here, in the present embodiment, as shown in FIG. 3A, the inclined wires 30A, 30B are disposed to extend in a direction in which the inclined wires are inclined with respect to the seat width direction between the seatback frame 18 and the seatback pad 17. Therefore, in a case where the lumbar region L on the outer side of the cornering direction is displaced toward the rear side of the vehicle, tension is generated in the inclined wire 30B, and the tension can be transmitted to, via the inclined wire 30B, the shoulder region S on the inner side of the cornering direction as a reaction force.

More specifically, in the analyzed result, as shown in a part (A) of FIG. 5, the reaction force received from the seatback 16 appears at two places as reaction force portions FB, FC. The reaction force portion FB is positioned above the center of the back of the occupant M as compared with the reaction force portion FA, and the reaction force portion FC is positioned on the shoulder region S on the inner side of the cornering direction. That is, the reaction force toward the shoulder region S on the inner side of the cornering direction can be ensured. Accordingly, as shown in FIG. 3B, a reaction force F from the inclined wire 30 is applied to the resultant force P of a force due to a change in the posture of the occupant M during the cornering and a centrifugal force acting on the occupant due to the cornering of the vehicle. As a result, even a part of the upper torso of the occupant M corresponding to the inner side of the cornering direction is brought into contact with the seatback 16, and the fit between the seatback 16 and the entirety of the upper torso of the occupant M is improved.

Further, as shown in FIG. 3A, the inclined wires 30A, 30B are disposed to be inclined with respect to the seat width direction to intersect each other at the lumbar region L of the occupant M. Therefore, a center point of the pressure that the back of the occupant M receives from the seatback 16 shifts toward an upper side of the seat, and the shear moment MO resisting the cornering G is easily obtained, as compared with a case where the wire 26 is extended horizontally in the seat width direction.

More specifically, as shown in FIG. 6A, the shear moment MO is generated to be parallel to a seat surface. Here, the reaction forces FB, FC by the inclined wire 30 of the present embodiment appear to push the upper torso of the occupant M upward as compared with the reaction force FA by the wire 27 of the comparative example. Accordingly, the position that receives the reaction force of the lumbar region L and the thoracic vertebra C is moved toward the upper side (see the part (A) of FIG. 5 and the part (B) of FIG. 5).

From the above description, the center point of the pressure of the upper torso of the occupant M moves upward, and the arm length that receives the shear moment MO increases. In addition, since a contact surface between the back of the occupant and the seatback 16 increases, the friction due to the reaction force increases. Accordingly, the shear moment MO resisting the cornering G is easily obtained, and the head and the upper torso are easily supported.

As a result, in the embodiment, the holding performance for the upper torso of the occupant M and the stability of the head H are improved during the traveling of the vehicle, particularly during the cornering.

As described above, the vehicle seat 10 according to the present embodiment can improve the holding performance for the upper torso of the occupant M and the stability of the head H during the traveling of the vehicle, particularly during the cornering.

In addition, in the present embodiment, since the horizontal wire 28 is configured to extend in the seat width direction through the sacral region LA of the occupant M and to support the sacral region LA of the occupant M, the horizontal wire 28 follows the lumbar region L of the occupant M that is displaced during the cornering to support the lumbar region L, and maintains the upright pelvis posture.

As a result, the vehicle seat 10 according to the present embodiment can improve the stability of the physical balance of the occupant M by maintaining the upright pelvis posture of the occupant M.

Further, in the present embodiment, since the intersecting portion 32 at which the inclined wires 30A, 30B intersect each other is disposed at a position corresponding to the fourth lumbar vertebra L4 of the occupant M, the intersecting portion 32 can support the fourth lumbar vertebra L4 that is the lumbar rotation axis of the occupant M during the cornering.

As a result, the vehicle seat 10 according to the present embodiment can suppress the rotation of the occupant M in the yaw direction during the cornering.

In addition, in the present embodiment, the inclined wires 30A, 30B are configured with the wires 26. Therefore, the strength and durability of the member increase, and the structure that generates the reaction force can be maintained, and the maintainability such as re-tensioning of the member is improved.

As a result, the vehicle seat 10 according to the present embodiment can suppress the decrease in the performance of supporting the back of the occupant M with respect to the load repeatedly applied from the occupant M during the cornering.

In the embodiment, the horizontal wire 28 is provided, but the present disclosure is not limited thereto, and the horizontal wire 28 may be omitted.

In the present embodiment, the wire 26 is used as the first support member, the second support member, and the third support member, but the present disclosure is not limited thereto, and a member having a belt shape may be used.

In the present embodiment, the inclined wires 30A, 30B are each provided in three strands. However, the present disclosure is not limited thereto, and as shown in FIG. 4A, the inclined wires 30 may be configured with the inclined wires 30A, 30B each provided in one strand. As shown in FIG. 4B, the inclined wires 30 may be configured with the inclined wires 30A, 30B each provided in four strands. The number of the inclined wires 30 may be any number other than the above. In addition, the inclination angle and the vertical distance between the inclined wires 30A, 30B can be optionally changed with a displacement in which an effect is obtained.

Further, in the present embodiment, as shown in the part (A) of FIG. 2, the part (B) of FIG. 2, and FIGS. 3A to 3D, the wires 26 are configured with the inclined wires 30A, 30B each provided in three strands and one horizontal wire 28. However, the present disclosure is not limited thereto, and as shown in FIG. 4B, two horizontal wires 28 may be arranged in the vertical direction.

What is claimed is:

1. A vehicle seat comprising:
a seatback frame erected from a rear end portion of a seat cushion;
a seatback pad disposed on a seat front surface side of the seatback frame and supporting a back of an occupant;
a first support member having an elongated shape and disposed between the seatback frame and the seatback pad, the first support member being configured to extend in a direction inclined with respect to a seat width direction and to transmit a reaction force to the back of the occupant through tension; and
a second support member having an elongated shape and disposed between the seatback frame and the seatback pad, the second support member being configured to extend in a direction inclined with respect to the seat width direction to intersect the first support member at a lumbar region, and to transmit a reaction force to the back of the occupant through tension.

2. The vehicle seat according to claim 1, further comprising a third support member having an elongated shape, the third support member being configured to extend in the seat width direction through a sacral region of the occupant and to support the sacral region of the occupant.

3. The vehicle seat according to claim 1, wherein an intersecting portion at which the first support member and the second support member intersect each other is disposed at a position corresponding to a fourth lumbar vertebra of the occupant.

4. The vehicle seat according to claim 1, wherein the first support member and the second support member are configured with a wire.
